(19) United States
(12) Patent Application Publication
(10) Pub. No.: US 2010/0319229 A1
(43) Pub. Date: Dec. 23, 2010

(54) ORBITAL SIGN ASSEMBLY

(76) Inventors: Vance Joseph Alan MCCOY, Atlanta, GA (US); Alexis Ivan WERTELECKI, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/852,149

(22) Filed: Aug. 6, 2010

Related U.S. Application Data
(63) Continuation-in-part of application No. 12/062,180, filed on Apr. 3, 2008.

(51) Int. Cl. G09F 7/22

(52) U.S. Cl. 40/606.01

(57) ABSTRACT

A sign assembly for securing a sign to a cable. The sign assembly comprises a cylindrical saddle with an exterior surface, a hollow core and an elongated slot. The saddle comprises at least one pair of longitudinally-aligned ridges elongated longitudinally along the exterior surface. The sign assembly comprises a pivot arm rotationally secured between the at least one pair of longitudinally-aligned ridges on the cylindrical saddle exterior surface and a sign mount secured to the pivot arm.

### CROSS REFERENCE TO RELATED APPLICATION

This application is a continuation-in-part of and claims the priority benefit of U.S. patent application Ser. No. 12/062,180 filed Apr. 3, 2008, the entirety of which is hereby incorporated herein by reference for all purposes.

### BACKGROUND OF THE INVENTION

1. Field of Invention

This invention relates to hangers, specifically to an improved traffic signage/device hanger to be used mainly in conjunction with a support member such as a span wire.

2. Discussion of Prior Art

One of the oldest sign hangers (that is still in use) uses a bracket that fastens to a support member or span wire through the use of two cable clamps. Two vertical slots are cut into this bracket through which two bolts are inserted and fastened to a long thin piece of flat bar steel. A traffic sign is attached to this flat bar steel through the use of additional bolts. The purpose of the two vertical slots and the bracket is to allow for the traffic sign to be adjusted for cant tilt (since the span wire may not be level). A disadvantage to this system is that when the wind blows, the sign transfers torque directly to the span wire since it is rigidly attached. This will eventually result in damage, loosening, and unbundling of associated electrical, traffic signal cables and vehicle-detection cables. In a worst case scenario, the span wire can break causing all of the attached traffic signals and signage to fall onto the roadway.

Another type of sign hanger in use has the advantage over the previous in that it allows the sign to pivot in a forward and backward motion for a total of 180 degrees, but the ability to cant tilt is eliminated. This 180 degree range of motion reduces torque applied to the span wire, however, it does not completely eliminate it. Again because this hanger like the previously mentioned one is rigidly attached directly to the span wire, torque is still applied when the sign moves. The ability to adjust the facing direction of the sign was added in this design. This allowed the sign to be positioned on a horizontal axis in a multitude of angles to accommodate for the angle of approach and direction of the street. Still this system like the first does not prevent unbundling and damage to cables, which can lead to costly and dangerous repairs.

The most modern sign hanger combines all the advantages of the previously mentioned hangers. Yet, again because it is rigidly attached to the span wire and only able to pivot 180 degrees, in extreme weather conditions the sign can flip over and twist causing damage to the span wire and cables.

### SUMMARY

In accordance with the present invention, an orbital sign assembly comprises mainly a cable saddle which attaches to a span wire or support member and acts as a bearing or chassis, a pivot attachment that rotates or orbits about the cable saddle, and a sign bracket for attachment of various signage. The pivot attachment joins the cable saddle with the sign bracket.

### BRIEF DESCRIPTION OF DRAWINGS

In certain figures closely related parts have the same number but different alphabetic suffixes.

FIG. 1 is an isometric view of an orbital sign assembly according to an example embodiment of the present invention, showing a span wire and two other (utility) cables crossing through and its orbital capability.

FIG. 2 is a front view of the embodiment of FIG. 1, showing its cant tilt capability.

FIG. 3 is a side view of the embodiment of FIG. 1.

FIG. 4 is an isometric view of a saddle washer coupled with a U-bolt and lock nut of the present invention.

FIG. 5 is an exploded view of the embodiment of FIG. 1.

FIG. 6 is a perspective view of an orbital sign assembly according to a second example embodiment of the present invention.

FIG. 7 is a side view of the embodiment shown in FIG. 6.

FIG. 8 is a top view of the embodiment shown in FIG. 6.

FIG. 9 is an exploded view of the embodiment shown in FIG. 6.

FIG. 10 is a view of the embodiment shown in FIG. 6, shown in an angled optional state.

FIG. 11 is a view of the embodiment shown in FIG. 6, shown in a second angled optional state.

### DETAILED DESCRIPTION

Reference now will be made in detail to the embodiments of the invention. It will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the procedures are well known and commonly employed in the art. Conventional methods are used for these procedures, such as those provided in the art and various general references. Where a term is provided in the singular, the inventor also contemplates the plural of that term. The nomenclature used herein and the devices and procedures described below are those well known and commonly employed in the art. All patents listed herein are expressly incorporated by reference in their entirety.

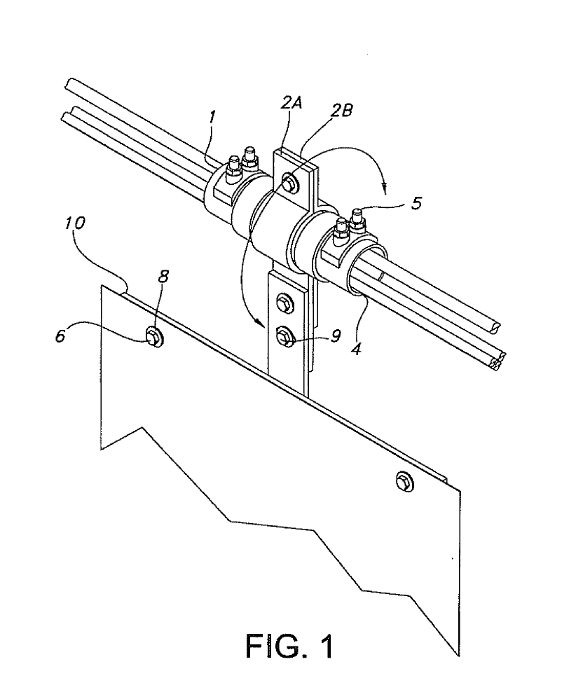

FIG. 1 shows a perspective view of the preferred embodiment of the orbital sign assembly. The orbital sign assembly includes mainly a cable saddle 1, a pivot attachment 2, and a sign bracket 10. The cable saddle is cylindrical in shape and acts as a bearing or chassis to which the pivot attachment attaches. The pivot attachment 2 is comprised of two pieces 2a and 2b which are joined together at top and bottom. The pivot attachment 2 has two semicircle sections that when joined form a circular opening that allows for the cable saddle 1 to be enclosed about. The pivot attachment 2 has two ends. At one end there is the above mentioned circular opening and at the other an attachment point for the sign bracket 10.

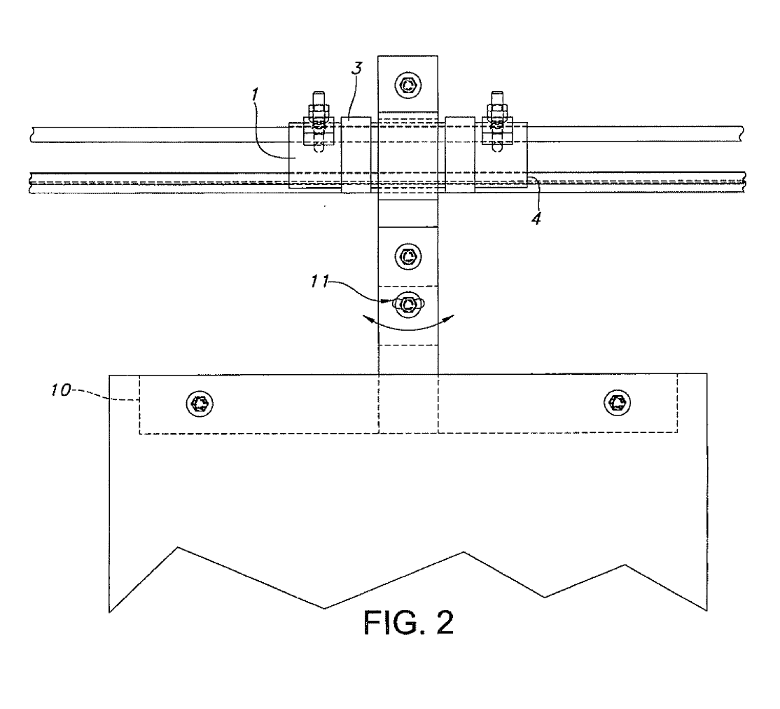

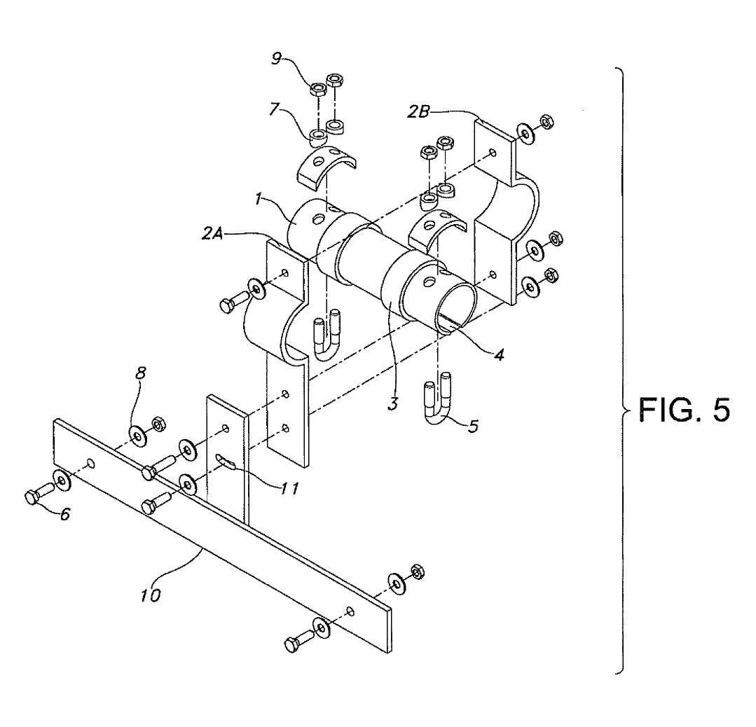

The cable saddle 1 (FIG. 1) as previously stated, is cylindrical in shape and includes two rings, guides, or pivot attachment rails 3 (FIG. 2). The pivot attachment rails 3 are raised above the contour of the cable saddle and spaced appropriately to accommodate the pivot attachment 2 when attached to the cable saddle 1. The pivot attachment rails 3 have a circular cross section and their raised edge is flat and runs parallel to the edge of the cable saddle. The cable saddle 1 also has a channel, opening or cable slot 4 (FIG. 5) dividing its lower side. Also the cable slot 4 intersects the pivot attachment rails 3. The cable slot 4 divides the full length of the cable saddle 1. I presently contemplate that the cable saddle 1 be 20 cm in length having a circular cross section of 6 mm with a diameter of 9 cm. I also contemplate that the pivot attachment rails 3 will have a circular cross section of 6 mm and be raised 6 mm above the edge of the overall body of the cable saddle 1 with a flat edge 3 cm in width that encircles the cable saddle Furthermore, I contemplate that the cable slot 4 will be 4 cm in width. Finally I contemplate that the cable saddle 1 including the pivot attachment rails 3 will be made from an investment casting using an aluminum alloy, but all aforementioned components can be of different sizes and materials, such as steel, titanium, polycarbonate, etc.

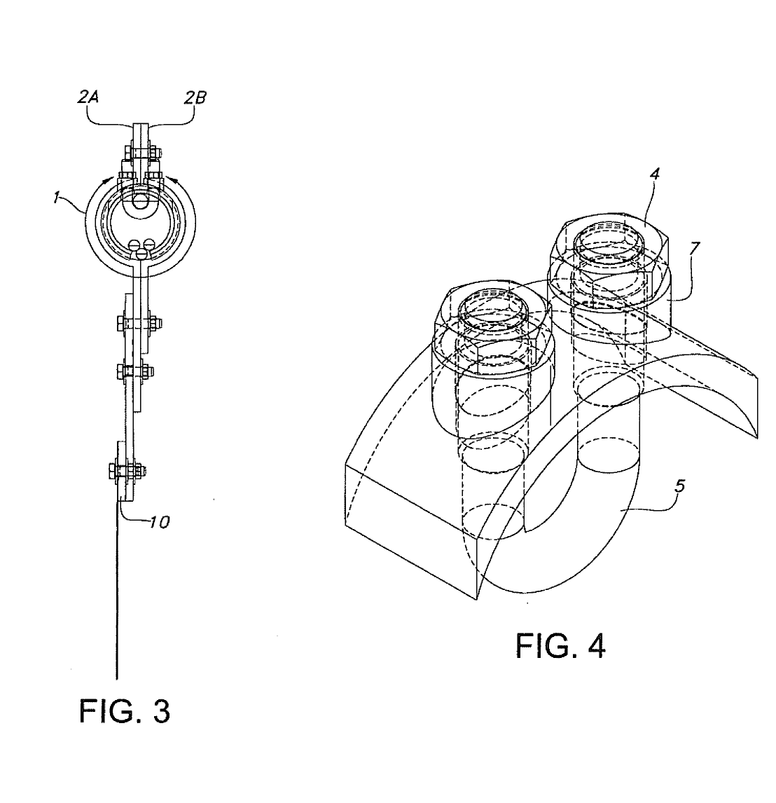

FIGS. 2 and 3 show an overall side and front view of the orbital sign assembly. There are two U-bolts 5 (FIG. 4) that are threaded at both ends. The U-bolts 5 are positioned on opposite sides of the pivot attachment rails 3. The U-bolts 5 are inserted from the inside of the cable saddle 1 with the threaded ends facing outward and passing through individual openings and then mating with a saddle washer 7 and lock nut 9. The saddle washer 7 (FIG. 4) is rounded on one face allowing it to mount flush against the cable saddle 1. The opposite face of the saddle washer 7 has two raised cylindrical openings for the threaded ends of the U-bolts 5 to pass through and respectively mate with the lock nuts 9. The U-bolts 5 should be long enough to accommodate a cable, span wire or support member of a multitude of diameters. At present I contemplate the U-bolts 5 and lock nuts 9 to be made of carbon steel and the saddle washer 7 to be made of an aluminum alloy.

Referring back to the pivot attachment 2 (FIGS. 1 and 3), the pivot attachment includes two parts 2a and 2b. The pivot attachment 2a and 2b are joined at an attachment point on the top and bottom. The pivot attachment 2a is longer on its lower end than pivot attachment 2b and includes an additional attachment point for attaching the sign bracket 10. At present I contemplate that the pivot attachment 2 will have a rectangular cross section of 7 cm by 5 mm and be stamped from a piece of aluminum alloy bar stock. However it can have a different cross sections, shape, and be made a different size using different materials. I also contemplate that the length of the pivot attachment 2a will have a length of 15 cm from the base of the semicircle section to the bottom end and the pivot attachment 2b have a length of 9 cm from the base of the semicircle section to its bottom end. The attachment points of the pivot attachment 2 (FIG. 3) will be fastened using a bolt 6 washer 8 and lock nut 9. I contemplate that the sign bracket 10 could be permanently affixed to the pivot attachment 2 or various other methods could be used to respectively join the two parts together.

The sign bracket 10 (FIG. 2) is composed of a top section and a lower section. The top section adjoins at the middle of the lower section. The top section has an attachment point at its top end and a cant tilt slot 11 at its middle. The lower section has attachment points at opposite ends and may have a plurality in between, (depending on the sign to be attached.) The cant tilt slot 11 is semicircle in shape and has a radius of approximately 25 mm. I contemplate that the top section will have a rectangular cross section of 16 cm by 5 mm and the lower section 30 cm by 5 mm. The sign bracket 10 is composed of one piece which will be stamped from aluminum alloy bar stock. Furthermore it can have different cross sections, shapes, and be made a different size using different materials.

### Operations

The cable saddle 1, pivot attachment 2, and the sign bracket 10 are the key components of the orbital sign hanger. Firstly, the cable saddle 10 (FIG. 1) serves as a chassis or bearing about which the pivot attachment 2 can freely orbit. Its circular shape, when coupled with the circular opening of the pivot attachment 2, allows for seamless movement in a 360 degree range of movement. The pivot attachment 2, the sign bracket 10, and finally whatever signage that may be attached is able to rotate 360 degrees as well. The pivot attachment rails 3 (FIG. 1) limit the side to side movement of the pivot attachment and control the damage that could result if the pivot attachment 2 were allowed to move about freely. The cable slot 4 (FIG. 5) allows for various cables, including the span wire, to be inserted into the cable saddle 1 and move unrestricted in the channel through the center of the cable saddle 1. Furthermore the cable slot 4 allows for additional cables to be inserted into the cable saddle 1 even after the initial installation, without removing the cable saddle from the span wire. The U-bolts 5 (FIG. 4) fasten to a span wire or other support member giving the present embodiment rigidity yet at the same time not impeding the movement of the pivot attachment 2 and sign bracket 10. Thus, the torque and stress applied to the span wire or support member, as seen in all prior art, is virtually eliminated.

In further detail, the pivot attachment 2 (FIG. 1), acts as an arm or lever that orbits around the cable saddle. In windy conditions, like those that occur during a hurricane or tornado, the pivot attachment can orbit freely about the cable saddle 1 and between the pivot attachment rails 3. The pivot attachment 2 also provides a way of attaching the sign bracket 10 and hence any signage with the cable saddle 1.

The sign bracket 10 most importantly forms a rigid backing or plate about which the attached signage can be affixed and rest against. Secondly the cant tilt slot 11 (FIG. 2), allows for 120 degrees of adjustment from side to side which allows for leveling of various signage hung from uneven span wires or support members. Finally, the cant tilt slot 11 serves as an additional attachment point between the pivot attachment 2 and the sign bracket 10.

### CONCLUSION, RAMIFICATIONS, AND SCOPE

Accordingly, the reader will see that at least one embodiment of the orbital sign assembly provides for more efficient, cost effective, and safer device that can be easily installed and maintained. Furthermore, the orbital sign assembly has the additional advantages in that it eliminates dangerous and costly repairs by reducing stress applied to the span wire and other cables which leads to less failures and eventual replacements; it uses many simple, readily available parts that are easy to identify and purchase; and it can be adapted for use with signage of most any size and weight.

Although the above description contains many details specific to present embodiment, these should not be construed as limitations on the scope of the embodiment, but rather as an exemplification of one preferred embodiment thereof. Other variations are possible. For example, the sign bracket could be lengthened to accommodate larger signage. A different material could be used in the manufacturing—such as a polymer based material. The assembly could be made smaller to accommodate smaller signage. The sign bracket 10 and pivot attachment 2a could be combined and manufactured as one piece. Even the saddle washer could be combined as an integral part of the cable saddle. Accordingly, the scope of the invention should be determined not by the embodiment illustrated, but by the appended claims and their legal equivalents.

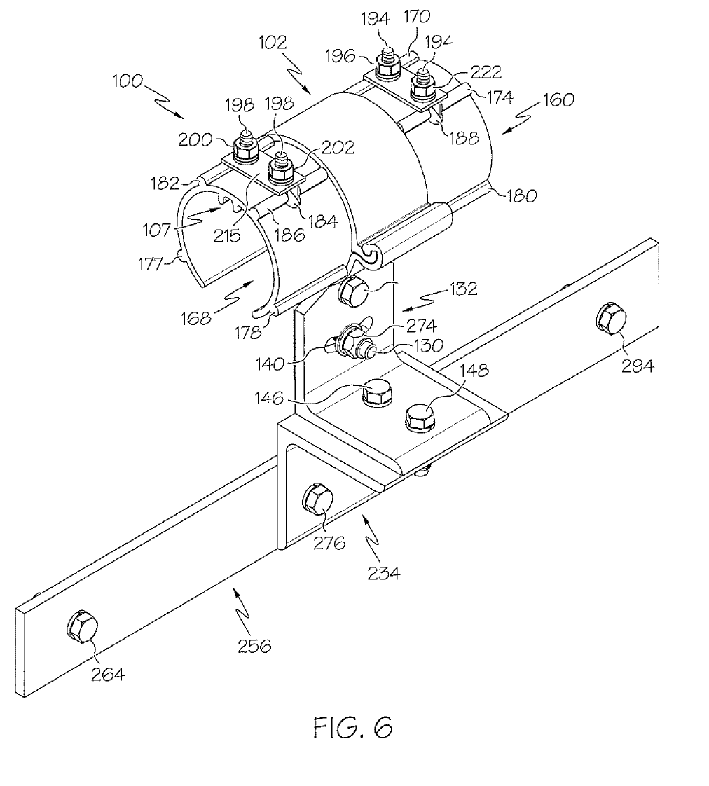

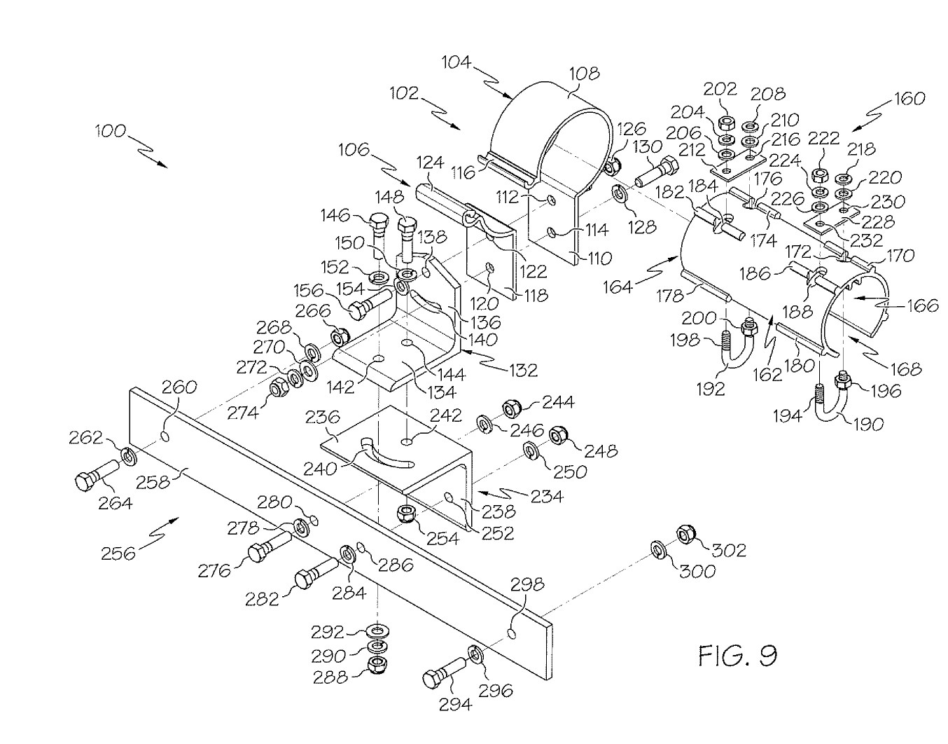

An ALTERNATIVE EMBODIMENT 100 is shown in FIGS. 6-11. The alternative embodiment 100 includes a saddle 160 that is secured within a pivot arm sleeve 102. The pivot arm sleeve 102 is secured to an upper angle adjustment body 132, which is secured to a lower angle adjustment body 132. The lower angle adjustment body 132 is secured to a sign bar mount 256. The alternative embodiment includes the ability to change the vertical and horizontal angles in which an attached sign will hang from the sign bar mount 256.

As shown, an example saddle 160 includes a cylindrical shape with an interior hollow core 166. The example saddle 160 preferably includes an open slot 168 extending the entire length of the saddle. Preferably, the open slot 168 has a width large enough to allow electrical cables to be inserted into the interior space 166 of the saddle 160. An example width of the open slot 168 is between about one inch and about two inches. Most preferably, the open slot 168 includes a width of about one and one half inches. Preferably, the example saddle 160 includes a length of about six inches and a diameter of about three inches. The example saddle 160 preferably includes a cross-sectional thickness of about 0.25 inches.

The interior surface of the example saddle 160 includes a smooth surface. The exterior surface of the example saddle 160 includes a plurality of raised ridges. The example saddle 160 can comprise at least four raised ridges 170, 174, 182, 186. Each of the raised ridges 170, 174, 182, 186 has an equal length and extends from an end of the saddle 160 toward the opposite end of the example saddle. Preferably, these raised ridges 170, 174, 182, 186 are arranged into two sets of parallel pairs and such that each pair is aligned longitudinally with the opposite pair. As shown, a first pair of ridges 182, 186 extends from one end of the example saddle 160 and a second pair of ridges 170, 174 extends from the opposite end of the saddle. Preferably, the first and second pair of ridges are separated longitudinally by a distance similar, or slightly less than, the width of the pivot arm sleeve 102 described below.

The example saddle 160 can comprise four elongated apertures 172, 176, 184, 188 that intersect the raised ridges 170, 174, 182, 186 in a perpendicular direction. As shown, the example elongated apertures 172, 176, 184, 188 bisect the raised ridges 170, 174, 182, 186. As further shown, the first and second pair of raised ridges 170, 174, 182, 186 are located opposite the open slot 168 on the circumference of the saddle 160.

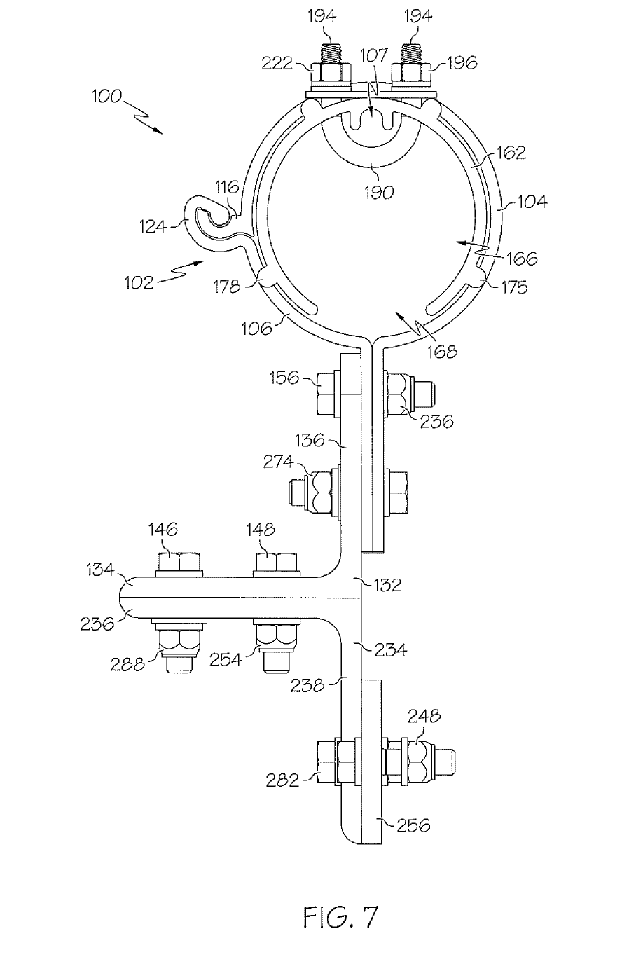

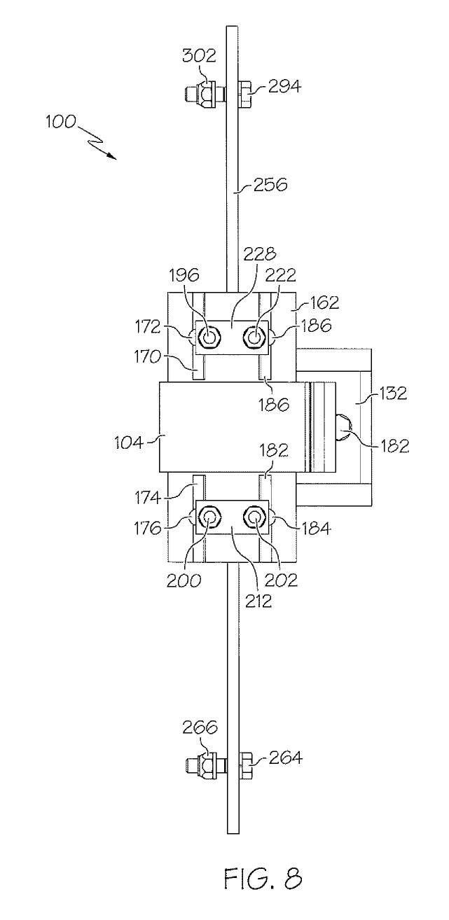

The example saddle 160 can comprise at least four further raised ridges 177, 178, 180, 175 (FIG. 7). Each of these additional further raised ridges 177, 178, 180, 175 includes an equal length and extends from an end of the example saddle 160 toward the opposite end of the saddle. Preferably, these further raised ridges 177, 178, 180, 175 are arranged into equal sets of parallel pairs and such that each pair is aligned longitudinally with the opposite pair. As shown, a first pair of ridges 177, 178 extends from one end of the saddle 160 and a second pair of ridges 175, 180 extends from the opposite end of the example saddle. Preferably, the first and second pair of these ridges are separated longitudinally by a distance similar, or slightly less than, the width of the pivot arm sleeve 102 described below. As shown, each pair of raised ridges 177, 178, 180, 175 is located along each side of the access slot 168 on the exterior surface of the saddle 160.

As further shown, the example saddle 160 can comprise a channel 107 extending longitudinally the entire length of the interior surface. An example channel 107 includes two parallel vertical walls extending outwardly from the interior surface and a semi-circular interior surface between the two walls. As shown, the example channel 107 is located on the interior surface of the saddle 160 at a location opposite, and between, the raised ridges 170, 174, 182, 186. The example channel 107 semi-circular surface preferably includes a 0.125 inch radius so that an electrical span wire can be secured within the parallel walls.

As further shown, support members 190, 192 can be secured to the saddle 160. Example support members 190, 192 are U-bolts with two parallel legs 194, 198 connected on one end by a rounded section. The ends of the parallel legs 194, 198 comprise threaded sections. Preferably, the parallel legs 194, 198 are inserted upwardly from the interior surface and through the elongated slots 172, 176, 184, 188 to the exterior surface. The rounded sections of each support member U-bolt 190, 192 remains within the interior of the saddle 160 and extends across the channel 107. As shown, plates 215 and 228 are rested perpendicularly across the raised ridges 170, 174, 182, 186. As shown, each plate 215, 228 includes a pair of apertures 212, 216, 230, 232. When rested across the raised ridges, the plate apertures align vertically with the elongated slots 172, 176, 184, 188. When inserted through these elongated slots, the parallel legs 194, 198 of the support member U-bolts insert through the plate apertures 212, 216, 230, 232.

The support member U-bolts 190, 192 are preferably then secured by placing washers 204, 206, 208, 210, 218, 220, 224, 226 over the parallel legs 194, 198 of the support member U-bolts 190, 192. And, internally threaded nuts 196, 200, 202, 222 are secured around correspondingly threaded sections on the support member U-bolt parallel legs. Preferably, an electrical span wire can be secured within the curved section of the U-bolts 190, 192 to prevent excessive movement of the saddle 160 with respect to the electrical span wire.

As shown, the example saddle 160 is secured within a pivot arm 102. An example pivot arm 102 includes a cylindrical sleeve and a planar body. Preferably, the cylindrical sleeve includes a hollow core having a diameter slightly larger than the outer diameter of the saddle 160. And, the planar body includes a pair of vertically aligned apertures.

As shown, the example pivot arm sleeve 102 includes a majority member 104 and a minority member 106. The majority member 104 includes a planar body 110, a cylindrical sleeve 108 and a lock grip 116. The majority planar body 110 includes a pair of apertures 112, 114 aligned vertically. The majority cylindrical sleeve 108 includes a diameter slightly larger than the outer diameter of the saddle 160. The majority cylindrical sleeve 108 is incomplete and includes a gap between the lock grip 116 and the planar body 110. The minority member 106 includes a planar body 118, a cylindrical sleeve 117 and a lock grip 124 that correspondingly grips with the majority lock grip 116. The minority planar body 118 includes a pair of vertically aligned apertures 120, 122. The minority cylindrical sleeve 117 is incomplete and includes a theoretical diameter equivalent to the majority cylindrical sleeve 108. As shown, the width of the example pivot arm 102 is slightly less than the distance between the raised ridges on the saddle 160 so that the pivot arm 102 remains secured between the raised ridges.

The example saddle 160 is inserted within the interior of the majority cylindrical sleeve 108 such that the majority cylindrical sleeve rests between the longitudinally spaced pairs of raised ridges. The minority member 106 is then mated with the majority member 104 such that the first 116 and second 124 lock grips engage each other. As mated, the minority cylindrical sleeve 117 aligns to complete the gap in the majority cylindrical sleeve 108 and complete the circumference of the pivot arm cylindrical sleeve. The raised ridges each have a height that extend beyond the cross sectional thickness of the majority and minority cylindrical sleeves 108, 117. The height of the raised ridges on the saddle provides a restriction of horizontal movement of the pivot arm.

As mated, the majority planar body 110 aligns in parallel to face the minority planar body 118. Preferably, the majority apertures 112, 114 align with the minority apertures 120, 122.

As shown, the alternate embodiment 100 further includes an angle adjustment member. An example angle adjustment member includes an upper angle adjustment member 132 and a lower angle adjustment member 234. An example upper angle adjustment member 132 includes a vertical plane 136 and a horizontal plane 134; each perpendicularly-angled with respect to each other. The vertical plane 136 and the horizontal plane 134 each comprise flat planar surfaces of equivalent cross-sectional thickness. The vertical and horizontal planes each have a width nearly equivalent to the width of the pivot arm planar bodies 110, 118.

The upper angle adjustment member vertical plane 136 includes an upper triangular-shaped surface having two surfaces of even length angled upwardly towards a midpoint along the width. The vertical plane 136 includes an upper aperture 138 located in vertical alignment with a horizontal axis midpoint. The vertical plane 136 further includes a semi-circular aperture 140 located below the upper aperture 138. The midpoint of the semi-circular aperture 140 is longitudinally-aligned with the upper aperture 18. And, the curvature of the semi-circular aperture 140 is angled upwardly toward the upper surface. The horizontal plane 134 includes two apertures 142, 144 each aligned at the midpoint of the width of the horizontal section.

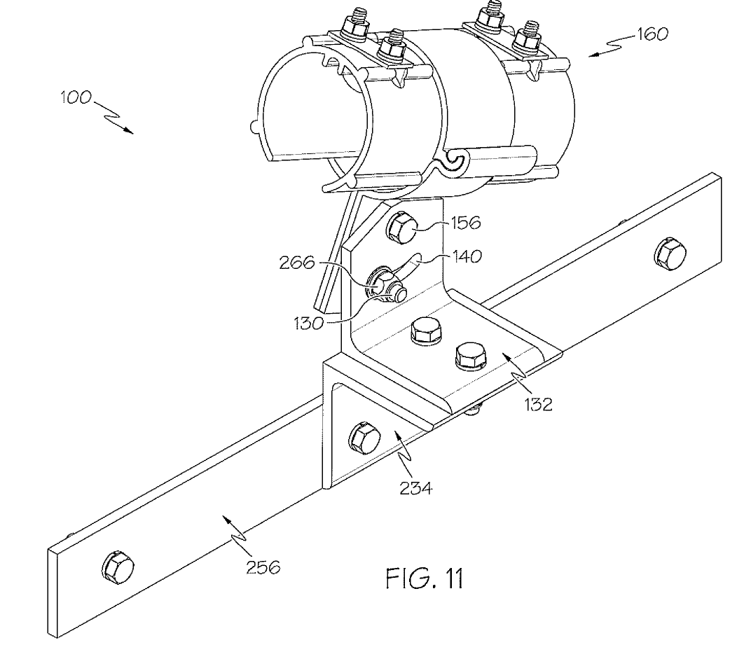

As shown, the upper angle adjustment vertical plane 134 aligns in parallel to face the planar bodies 110, 118 of the pivot arm 102. A fastener (screw) 156 is inserted through a washer 154, then through aperture 138 and through apertures 122, 112. The screw is secured with a nut 126 on the opposite side of planar body 110 from where it entered. A second fastener (e.g., screw) 130 is oppositely inserted through a washer 128 and first through apertures 114 and 120, then through semi-circular aperture 140. The screw 130 is then secured on an outer surface of the semi-circular aperture 140 with a nut 266. As shown in FIG. 11, the semi-circular aperture 140 provides the ability to adjust the angle of the pivot arm 102 in either direction with respect to the upper angle adjustment member by securing screw 130 at a particular location within the semi-circular aperture.

Instead of screws and nuts, other conventional fasteners can be useful to provide this pivot and arcuate guideslot arrangement. For example, the utility of the semi-circular aperture 240 can be provided by a series of holes along a semi-circle and screws provided by pins that fit through the aperture and aligned with one of the several holes. In addition, the pivot arm can be provided by a conventional pivot pin or hinge assembly.

The example lower angle adjustment member 234 includes a horizontal plane 236 and a perpendicularly-situated vertical plane 238. The horizontal plane 236 includes a proximate first aperture 242 and a distal semi-circular aperture 240. The semi-circular aperture 240 is located at the distal end from the perpendicular intersection of the vertical 238 and horizontal 236 planes. The midpoint of the semi-circular aperture 240 is longitudinally-aligned with the proximate aperture 242 and the curvature of the semi-circular aperture is angled toward the perpendicular intersection of the horizontal 236 and vertical 238 planes.

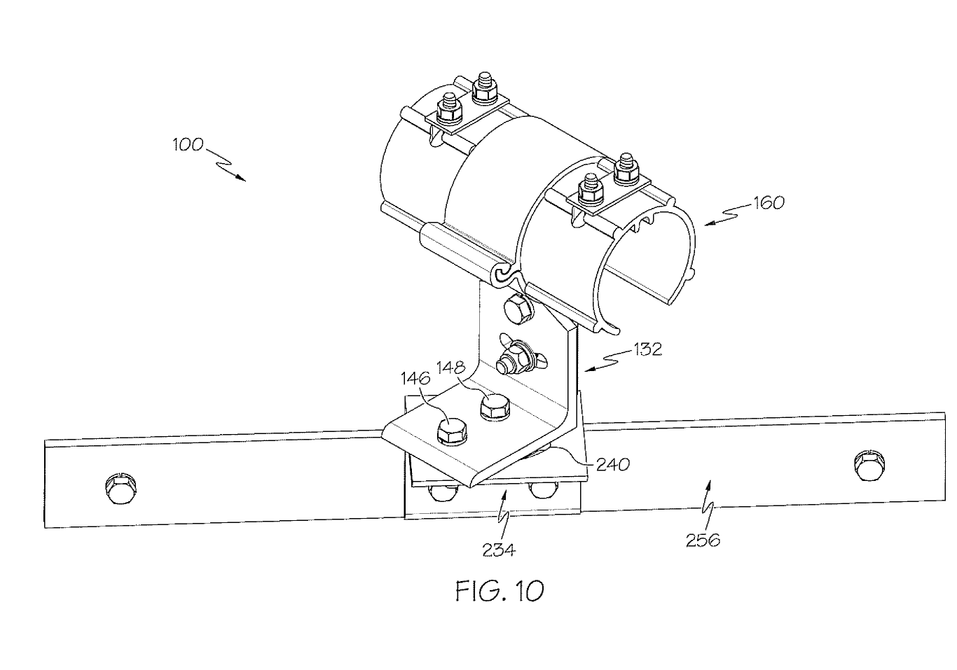

As shown, the lower angle adjustment horizontal plane 236 aligns in parallel to face the upper angle adjustment horizontal plane 134. The upper and lower angle adjustment vertical planes 136, 238 are linearly aligned. A screw 148 is inserted through a washer 150, then through aperture 144 and aperture 242. The screw is secured with a nut 254. A screw 146 is inserted through a washer 152 then through aperture 142 and semi-circular aperture 240. The screw 146 is then secured with washers 290, 292 and a nut 288. As shown in FIG. 10, the semi-circular aperture 240 provides the ability to angle the lower angle adjustment 234 horizontally in either direction with respect to the upper angle adjustment 132 by securing the screw 146 to a particular location along the semi-circular aperture 240.

Instead of screws and nuts, other conventional fasteners can be useful to provide this pivot and arcuate guideslot arrangement. For example, the utility of the semi-circular aperture 240 can be provided by a series of holes along a semi-circle and screws provided by pins that fit through the aperture and aligned with one of the several holes. In addition, the pivot arm can be provided by a conventional pivot pin or hinge assembly.

An example sign bar mount 256 secures to the vertical plane 238 of the lower angle adjustment member 234. The sign bar mount 256 includes an elongated rectangular and planar shape. Two internal apertures 280, 286 are located equal lengths form the midpoint along the sign bar mount 256. Two outward apertures 260, 298 are located equal lengths form the midpoint along the sign bar mount 256. The sign bar mount 256 aligns an parallel and faces the vertical plane 238 such that apertures 280, 286 align with the apertures in the vertical plane 252 and that not shown. A pair of screws 276, 282 are inserted through washers 278 then through the apertures in the sign bar mount 256 and the vertical plane 238. The screws are secured on the opposite side of the vertical plane 238 through washers 246, 250 and nuts 244, 248. A pair of screws 264, 294 inserts through washers 262, 296 and through outward apertures 260, 298. The screws 264, 294 are secured on the opposite side of the sign bar mount 256 with washers 268, 300 and nuts 266, 302. It is contemplated that a road sign can be secured on either side of the sign bar mount 256 and with either only the outward screws 264, 294 and/or the internal screws 276, 282.

Accordingly the invention improves upon the pivoting or rotation ability of the sign hanger about the span wire by using a circular shaped clamp or attachment that orbits about, allowing the sign bracket and attached signage to rotate a full 360 degrees in either direction. The use of a bearing or chassis allows electrical, traffic signal cables and vehicle detection cables to pass through untouched and unharmed by the rotation of the sign hanger about the span wire or other support member. The improved cant tilt by use of a semi circle shaped hole or slot allows for angular adjustment to level the physical sign when the hanger is hung on an unlevel span wire. The design eliminates or greatly reduces torque applied to the span wire thereby reducing and/or preventing costly repairs. The design allows free motion of the sign bracket and sign under high wind conditions like those found during hurricanes and tornadoes reducing possibility of all or part of sign assembly breaking away.

The invention has been described in detail, with particular reference to certain preferred embodiments, in order to enable the reader to practice the invention without undue experimentation. A person having ordinary skill in the art will readily recognize that many of the previous components, compositions, and/or parameters may be varied or modified to a reasonable extent without departing from the scope and spirit of the invention. Furthermore, titles, headings, example materials or the like are provided to enhance the reader's comprehension of this document, and should not be read as limiting the scope of the present invention. Accordingly, the invention is defined by the following claims, and reasonable extensions and equivalents thereof.

1. A sign assembly for securing a sign to a cable, comprising:
a cylindrical saddle comprising an exterior surface, a hollow core and an elongated slot, wherein the saddle comprises at least one pair of longitudinally-aligned ridges elongated longitudinally along the exterior surface;
a pivot arm rotationally secured between the at least one pair of longitudinally-aligned ridges on the cylindrical saddle exterior surface; and
a sign mount secured to the pivot arm.

2. The sign assembly of claim 1, wherein the at least one pair of longitudinally-aligned ridges comprises a first pair of longitudinally-aligned ridges extending inwardly from one end of the saddle and a second pair of longitudinally-aligned ridges extending inwardly from a second end of the saddle.

3. The sign assembly of claim 2, wherein the first and second pairs of longitudinally-aligned ridges are separated by a defined length.

4. The sign assembly of claim 3, wherein the pivot arm is secured between the first and second pairs of longitudinally-aligned ridges.

5. The sign assembly of claim 3, wherein the saddle further comprises a plurality of elongated apertures, wherein each elongated aperture perpendicularly bisects a longitudinally-aligned ridge from the first and second pair of longitudinally-aligned ridges.

6. The sign assembly of claim 1, further comprising a channel extending the length of the interior surface of the saddle.

7. The sign assembly of claim 6, further comprising at least one support secured within the saddle.

8. A sign assembly for securing a sign to a cable, comprising:
a cylindrical saddle comprising an exterior surface, a hollow core and an elongated slot, wherein the saddle comprises at least one pair of spaced ridges on the exterior surface;
a pivot arm rotationally secured about the saddle, wherein the pivot arm comprises majority and minority bodies secured through correspondingly curved locking grips; and
a sign mount secured to the pivot arm.

9. The sign assembly of claim 8, wherein the pivot arm majority body comprises an incomplete cylindrical sleeve and a grip, and wherein the minority body comprises an incomplete cylindrical sleeve and a grip.

10. The sign assembly of claim 9, wherein the minority cylindrical sleeve and the majority cylindrical sleeve combine to complete a circumference.

11. The sign assembly of claim 9, wherein the majority grip correspondingly locks with the minority grip.

12. The sign assembly of claim 8, wherein the pivot arm is rotationally secured between the at least one pair of spaced ridges on the saddle.

13. The sign assembly of claim 8, wherein the majority body comprises a planar body secured to the cylindrical sleeve, wherein the minority body comprises a planar body secured to the cylindrical sleeve, and wherein the majority planar body and the minority planar body comprise identical structures.

14. A sign assembly for securing a sign to a cable, comprising:
a cylindrical saddle comprising an exterior surface, a hollow core and an elongated slot, wherein the saddle comprises at least one pair of spaced ridges on the exterior surface;
a pivot arm rotationally secured about the saddle; and
a sign mount secured to the pivot arm with an angle adjustment mechanism.

15. The sign assembly of claim 14, wherein the angle adjustment mechanism comprises a vertical angle adjustment feature.

16. The sign assembly of claim 15, wherein the vertical angle adjustment feature comprises a semi-circular aperture for altering a vertical securing angle with respect to the pivot arm.

17. The sign assembly of claim 14, wherein the angle adjustment mechanism comprises a horizontal angle adjustment feature.

18. The sign assembly of claim 17, wherein the horizontal angle adjustment feature comprises a semi-circular aperture for altering a horizontal securing angle with respect to the pivot arm.

19. The sign assembly of claim 14, wherein the angle adjustment mechanism comprises a first body and a second body; wherein the first body is secured to the pivot arm; and wherein, the second body is secured to the sign mount.

20. The sign assembly of claim 19, wherein the first body comprises a vertically-oriented semi-circular aperture; and wherein the second body comprises a horizontally-oriented semi-circular aperture.
